(19) United States
(12) Patent Application Publication
(10) Pub. No.: US 2011/0039150 A1
(43) Pub. Date: Feb. 17, 2011

(54) ALKALINE PRIMARY CELLS

(76) Inventors: Yichun Wang, West Roxbury, MA (US); James Joseph Cervera, Sandy Hook, CT (US); Tatjana Mezini, Medford, MA (US); Kirakodu S. Nanjundaswamy, Sharon, MA (US); Fan Zhang, Needham, MA (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/541,217

(22) Filed: Aug. 14, 2009

(51) Int. Cl. H01M 6/04; H01M 2/02

(52) U.S. Cl. 429/163; 429/188; 429/199; 429/207

(57) ABSTRACT

A battery is described. The battery includes an anode, a cathode, a separator disposed between the cathode and the anode, and an electrolyte. The electrolyte further includes manganese. The manganese is selected from the group consisting of: cesium permanganate (CsMnO₄), cesium manganate (Cs₂MnO₄), magnesium permanganate (Mg(MnO₄)₂), magnesium manganate (MgMnO₄), silver manganate (Ag₂MnO₄), silver permanganate (AgMnO₄), barium manganate (BaMnO₄), and barium permanganate (Ba(MnO₄)₂).

### FIELD OF THE INVENTION

The invention relates to electrochemical cells or batteries thereof.

### BACKGROUND OF THE INVENTION

Electrochemical cells (batteries) are commonly used as electrical energy sources. A battery contains a negative electrode, typically called the anode, and a positive electrode, typically called the cathode. The anode contains an active material that can be oxidized. The cathode contains an active material that can be reduced. The anode active material is capable of reducing the cathode active material. A separator is disposed between the anode and cathode. These components are disposed in a metal housing (can).

A common anode material employed in both primary (single use) and secondary (rechargeable) batteries is zinc (Zn). Zn has beneficial characteristics, such as high capacity, high energy density, low cost, and non-toxicity. However, engineering issues may exist with the oxidation of Zn during storage or discharge of a battery. For example, the Zn anode may be prone to the generation of gas during storage or discharge. The gas generated may put stress on the assembled cylindrical battery and may lead to leakage. Similarly, in prismatic or button cell designs, for example, there may be an increased susceptibility to leakage due to internal gassing pressure. Additionally, the gas generated may have negative impacts on performance since the presence of gas may lead to increased cell impedance.

Battery engineers have attempted to suppress the generation of gas by creating alloys of Zn or by using additives within the anode. One example may be the addition of indium to Zn, either by alloying or blending, that may help reduce gas generation. Indium, however, is relatively expensive and its inclusion within an assembled battery may add significantly to product cost. Mercury has similarly been used in combination with Zn to help reduce gassing, particularly in button-cell applications, for example in Zn/Air hearing aid batteries. The use of mercury, however, may have potential negative environmental impacts due to its toxicity.

There is a growing need to improve the overall performance of batteries. Batteries have a predetermined internal volume that is dictated by the standard external geometries of battery types. Current battery designs include unoccupied space for gas that may be generated during storage or discharge of an assembled battery. Reduction of gas generation may reduce some need for unoccupied space within the internal volume of assembled cells. The unoccupied space may then be dedicated to additional active materials incorporated with assembled cells that may result in overall increased battery performance.

### SUMMARY OF THE INVENTION

One aspect of the invention features a battery. The battery comprises an anode, a cathode, a separator disposed between the anode and cathode, and an electrolyte. The electrolyte further comprises manganese. The manganese is selected from the group consisting of: cesium permanganate (CsMnO₄), cesium manganate (Cs₂MnO₄), magnesium permanganate (Mg(MnO₄)₂), magnesium manganate (MgMnO₄), silver manganate (Ag₂MnO₄), silver permanganate (AgMnO₄), barium manganate (BaMnO₄), and barium permanganate (Ba(MnO₄)₂).

In some implementations, the anode may further comprise an anode active material comprising zinc. The electrolyte may comprise an aqueous solution selected from the group consisting of: potassium hydroxide, sodium hydroxide, lithium hydroxide, zinc chloride, ammonium chloride, magnesium perchlorate, and magnesium bromide. The cathode may further comprise cathode active material. The cathode active material may be selected from the group consisting of: manganese dioxide, electrolytic manganese dioxide (EMD), chemical manganese dioxide (CMD), and high power electrolytic manganese dioxide (HP EMD). The battery may comprise a housing, the anode, the cathode, the separator, and the electrolyte disposed in the housing.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings.

FIG. 1 is a schematic diagram of a battery.

### DETAILED DESCRIPTION OF THE INVENTION

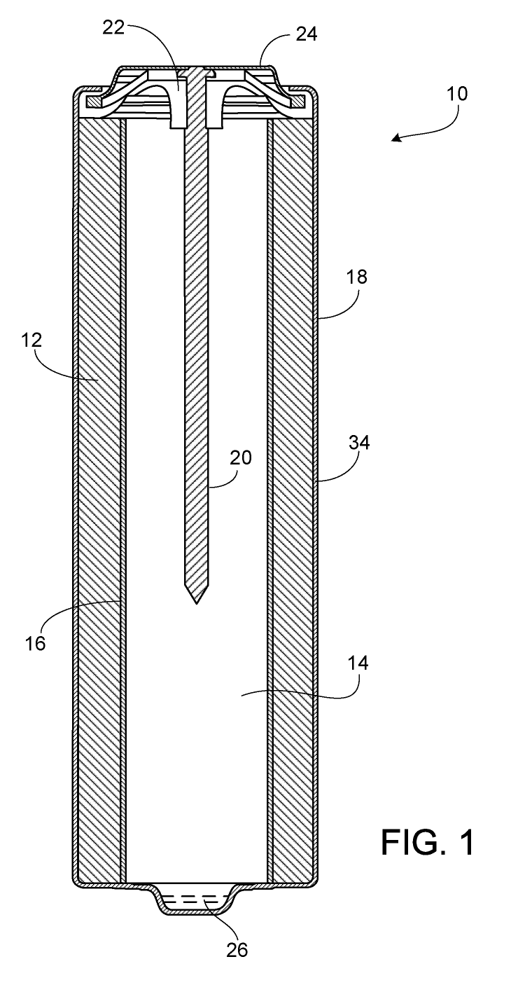

Referring to FIG. 1, battery 10 includes a cathode 12, an anode 14, and a separator 16 disposed in a cylindrical housing 18. Battery 10 also includes current collector 20, seal 22, and a negative metal end cap 24, which serves as the negative terminal for the battery. A positive pip 26, which serves the positive terminal of the battery, is at the opposite end of the battery from the negative terminal. An electrolytic solution is dispersed throughout battery 10. Battery 10 can be an alkaline battery, for example, an AA, AAA, AAAA, C, or D battery.

The cylindrical housing 18 may be thin walled, e.g., typically from about 0.25 mm to about 0.15 mm wall thickness for AA and AAA cells, and about 0.30 mm to about 0.20 mm for C and D cells.

Cathode 12 includes one or more cathode active materials, such as manganese dioxide, silver oxide, nickel oxyhydroxide, or copper oxide. Preferably, the cathode active material is selected from the group consisting of manganese dioxide, electrolytic manganese dioxide (EMD), chemical manganese dioxide (CMD) and high power electrolytic manganese dioxide (HP EMD).

A preferred cathode active material is manganese dioxide, having a purity of at least about 91 percent by weight. Electrolytic manganese dioxide (EMD) is a preferred form of manganese dioxide for electrochemical cells because of its high density and since it is conveniently obtained at high purity by electrolytic methods. Chemical manganese dioxide (CMD), a chemically synthesized manganese dioxide, has also been used as cathode active material in electrochemical cells including alkaline cells and heavy duty cells.

EMD is typically manufactured from direct electrolysis of a bath of manganese sulfate and sulfuric acid. Processes for the manufacture of EMD and its properties appear in Batteries, edited by Karl V. Kordesch, Marcel Dekker, Inc., New York, Vol. 1, (1974), p. 433-488. CMD is typically made by a process known in the art as the “Sedema process”, a chemical process disclosed by U.S. Pat. No. 2,956,860 (Welsh) for the manufacture of alkaline cell grade MnO₂ by employing the reaction mixture of MnSO₄ and an alkali metal chlorate, preferably NaClO₃. Distributors of manganese dioxides include Tronox, Chem Metals Co., Tosoh, Delta Manganese, Mitsui Chemicals, JMC, and Xiangtan.

In some implementations, high power (HP) EMD may be used. Preferably, the HP EMD has an open circuit voltage (OCV) of at least 1.635. A suitable HP EMD is commercially available from Tronox, under the trade name High Drain.

The cathode 12 may also include carbon particles and a binder. The cathode may also include other additives. The cathode 12 will have a porosity. The cathode porosity is preferably between about 22% and about 31%. The cathode porosity is a calculated value based on the cathode at the time of manufacturing. The porosity changes over time due to swelling associated with discharge and the electrolyte wetting.

% Cathode Porosity=(1−(cathode solids volume÷geometric cathode volume))×100

The carbon particles are included in the cathode to allow the electrons to flow through the cathode. The carbon particles may be of graphite, natural or synthetic grades. Natural graphite may be expanded or non-expanded type. Likewise, synthetic graphite may be expanded or non-expanded type. It is preferred that the amount of carbon particles in the cathode is relatively low, e.g., less than about 5.0%, or even less than about 4.5%, for example about 2.0% to about 3.5%. This carbon level allows the cathode to include a higher level of active material without increasing the volume of the cell or reducing the void volume (which must be maintained at or above a certain level to prevent internal pressure from rising too high as gas is generated within the cell).

Suitable expanded graphite particles can be obtained, for example, from Chuetsu Graphite Works, Ltd. (e.g., Chuetsu grades WH-20A and WH-20AF) of Japan or Timcal America (Westlake, Ohio). A suitable expanded graphite is available from Timcal under the tradename Timrex® BNB-90 graphite.

Some preferred cells contain from about 2% to about 4% expanded graphite by weight. In some implementations, this allows the level of EMD to be from about 89% to 91% by weight as supplied. (EMD contains about 1% to about 2% moisture as supplied, so this range equates to about 88% to 90% pure EMD.) Preferably, the ratio of cathode active material to expanded graphite is greater than 21, and more preferably greater than 25 or even greater than 27. In some implementations, the ratio is between 25 and 33, e.g., between 27 and 30. These ratios are determined by analysis, ignoring any water.

It is generally preferred that the cathode be substantially free of natural graphite. While natural graphite particles provide lubricity to the cathode forming equipment, this type of graphite is significantly less conductive than expanded graphite, and thus it is necessary to use more in order to obtain the same cathode conductivity. If necessary, the cathode may include low levels of natural graphite, however this will compromise the reduction in graphite concentration that can be obtained while maintaining a particular cathode conductivity.

The cathode may be provided in the form of pressed pellets. For optimal processing, it is generally preferred that the cathode have a moisture level in the range of about 2.5% to about 5%, more preferably about 2.8% to about 4.6%. It is also generally preferred that the cathode have a porosity of from about 22% to about 31%, for a good balance of manufacturability, energy density, and integrity of the cathode.

Examples of binders that may be used in the cathode include polyethylene, polyacrylic acid, or a fluorocarbon resin, such as PVDF or PTFE. An example of a polyethylene binder is sold under the trade name COATHYLENE HA-1681 (available from Hoechst or DuPont). Examples of other additives are described in, for example, U.S. Pat. Nos. 5,698,315, 5,919,598, and 5,997,775 and U.S. application Ser. No. 10/765,569.

Anode 14 can be formed of an anode active material, electrolyte, a gelling agent, and minor amounts of other additives, such as gassing inhibitor. The amount of anode active material may vary depending upon the active material selected and the cell size of the battery. For example, AA batteries with a zinc anode active material may have at least about 3 grams of zinc. AAA batteries, for example, with a zinc anode active material may have at least about 1.5 grams of zinc.

Examples of the anode active material include zinc, magnesium, and aluminum. Preferably, the anode active material includes zinc having a fine particle size, e.g., an average particle size of less than about 175 microns. The use of this type of zinc in alkaline cells is described in U.S. Pat. No. 6,521,378, the complete disclosure of which is incorporated herein by reference.

Additionally, the anode active material may be alloyed with other elements to provide beneficial characteristics when utilized in an assembled battery. For example, alloying the anode active material with indium may help in the reduction of gas formation during discharge of the anode active material.

Examples of a gelling agent that may be used include a polyacrylic acid, a grafted starch material, a salt of a polyacrylic acid, a carboxymethylcellulose, a salt of a carboxymethylcellulose (e.g., sodium carboxymethylcellulose) or combinations thereof.

Separator 16 can be a conventional alkaline battery separator. Preferably, the separator material is thin. For example, for an AA battery, the separator may have a wet thickness of less than about 0.30 mm, preferably less than about 0.20 mm and more preferably less than about 0.10 mm, and a dry thickness of less than about 0.10 mm, preferably less than about 0.07 mm and more preferably less than about 0.06 mm. The basis weight of the separator may be from about 15 to 80 g/m². In some preferred implementations the separator may have a basis weight of about 35 g/m² or less. In other embodiments, separator 16 may include a layer of cellophane combined with a layer of non-woven material. The separator also can include an additional layer of non-woven material.

In some implementations, the separator is wrapped about a mandrel to form a tube. In such cases, in order to minimize cell distortion, it is generally preferred that the number of wraps of the separator is an integer or “whole number” (e.g., 1, 2, 3, 4 . . . ), rather than a fractional number (e.g., 1.25). When the number of wraps is an integer, the cell discharge around the cell circumference tends to be more uniform than if the number of wraps contains a fractional amount. Due to practical limitations on manufacturing, it may not be possible to obtain exactly integral (whole number) wraps, however it is desirable to be as close to integral as possible, e.g., 0.8 to 1.2, 1.8 to 2.2, 2.8 to 3.2, etc. Separator designs of this kind will be referred to herein as having “substantially integral wraps.”

An electrolyte may be dispersed throughout the cathode 12, the anode 14 and the separator 16. The electrolyte may comprise an ionically conductive component. The ionically conductive component may be an alkali hydroxide, such as potassium hydroxide, sodium hydroxide, or lithium hydroxide, or a salt such as zinc chloride, ammonium chloride, magnesium perchlorate, magnesium bromide, or their combinations. The electrolyte may comprise a solution, suspension, or dispersion. Preferably, the electrolyte is an aqueous solution.

The average concentration of the ionically conductive component in an aqueous electrolyte solution may be from about 0.23 to about 0.37 on a total weight basis of the electrolyte. For example, the electrolyte may comprise potassium hydroxide in an aqueous solution at an average concentration between about 0.26 and about 0.35 on a total weight basis of the electrolyte. In addition, the electrolyte may include zinc oxide (ZnO), for example about 2% ZnO by weight of electrolyte.

Housing 18 can be a conventional housing commonly used in primary alkaline batteries, for example, a housing formed from nickel plated cold-rolled steel. Current collector 20 can be made from a suitable metal, such as brass. Seal 22 can be made, for example, of a polyamide (Nylon).

The electrolyte also includes one or more electrolyte solution additives that may help reduce gassing internal to the assembled battery 10. The electrolyte solution additive includes manganese. The electrolyte solution additive may include soluble manganese. The soluble manganese may be capable of dissolving within the electrolyte. Once dissolved, the soluble manganese may diffuse through separator 16 and contact the anode active material of anode 14 of battery 10. When the materials contact one another, the anode active material may be partially oxidized to form a protective surface that may limit corrosion during the storage of the battery 10. Examples of soluble electrolyte solution additive include manganate salts and permanganate salts, e.g., cesium permanganate (CsMnO₄), cesium manganate (Cs₂MnO₄), magnesium permanganate (Mg(MnO₄)₂), magnesium manganate (MgMnO₄), silver manganate (Ag₂MnO₄), silver permanganate (AgMnO₄), barium manganate (BaMnO₄), and barium permanganate (Ba(MnO₄)₂).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A battery comprising:
an anode;
a cathode;
a separator disposed between said anode and said cathode; and
an electrolyte, said electrolyte comprising manganese:
wherein the manganese is selected from the group consisting of: cesium permanganate (CsMnO₄), cesium manganate (Cs₂MnO₄), magnesium permanganate (Mg(MnO₄)₂), magnesium manganate (MgMnO₄), silver manganate (Ag₂MnO₄), silver permanganate (AgMnO₄), barium manganate (BaMnO₄), and barium permanganate (Ba(MnO₄)₂).

2. The battery of claim 1 wherein said anode further comprises an anode active material comprising zinc.

3. The battery of claim 1 wherein the electrolyte comprises an aqueous solution selected from the group consisting of: potassium hydroxide, sodium hydroxide, lithium hydroxide, zinc chloride, ammonium chloride, magnesium perchlorate, and magnesium bromide.

4. The battery of claim 1 wherein the cathode comprises cathode active material.

5. The battery of claim 4 wherein the cathode active material is selected from the group consisting of: manganese dioxide, electrolytic manganese dioxide (EMD), chemical manganese dioxide (CMD), and high power electrolytic manganese dioxide (HP EMD).

6. The battery of claim 1 further comprising a housing, said anode, said cathode, said separator, and said electrolyte disposed in said housing.
